(19) United States
(12) Patent Application Publication
(10) Pub. No.: US 2005/0286349 A1
(43) Pub. Date: Dec. 29, 2005

(54) System for synchronizing clock settings

(76) Inventor: Lawrence E. Cook, Wanatah, IN (US)

Correspondence Address: HARSHAW RESEARCH INCORPORATED, P O BOX 418, OTTAWA, KS, 66067, US

(21) Appl. No.: 10/878,850

(22) Filed: Jun. 28, 2004

(51) Int. Cl. H04L 7/00

(52) U.S. Cl. 368/47

(57) ABSTRACT

A system for synchronizing clock settings includes a master clock and at least one slave clock. The master clock includes a master CPU connected to a receiver, master transceiver, master memory, and battery. Slave clocks each include a slave CPU connected to a slave transceiver and a slave memory. The receiver receives a radio signal having atomic clock time data, the master transceiver transmits the data to the slave transceivers, and the master CPU updates the master clock time. After slave transceivers receive the data, the slave CPUs update the slave clock time. Slave transceivers transmit respective slave clocks' local settings to the master transceiver. The master memory stores the slave clocks' local settings by ID and model number. After the master clock or a slave clock loses AC power, the system restores time and local settings. Only the master clock includes a battery for preserving all local settings.

### BACKGROUND OF THE INVENTION

This invention relates generally to a clock synchronizing system. In particular, the present invention relates to a system for synchronizing clock settings.

Power outages cause many delays and hassles. As society becomes more dependent on many types of electronic devices, the inconvenience caused by a drop in power becomes more insurmountable. Today clocks are becoming more universally applied to devices, and as devices incorporate more advanced technological features, more user settings are customized. The repeated setup of user settings and clock settings represent additional inconvenience for the average person. The purpose of the present system for synchronizing clock settings is to avoid this hassle by creating a radio network from slave devices to a master clock that synchronizes the clocks in the slave devices and saves and resets the user settings of the slave devices.

The National Institute of Standards and Technology (NIST) broadcasts a radio signal synchronized to an atomic clock. NIST radio station WWVB is located near Fort Collins, Colorado. The WWVB broadcasts are used by millions of people throughout North America to synchronize consumer electronic products like wall clocks, clock radios, and wristwatches. In addition, WWVB is used for high level applications such as network time synchronization and frequency calibrations.

WWVB continuously broadcasts time and frequency signals at 60 kHz. The time code contains the year, day of year, hour, minute, second, and flags that indicate the status of Daylight Saving Time, leap years, and leap seconds. By including the time zone setting in the master clock, the corresponding slave clocks can display the correct time. The time is kept to within less than 1 microsecond of Coordinated Universal Time (UTC) at the transmitter site, but the signal is delayed as it travels from the radio station to the reception location. This delay increases the further the reception location is from the radio station, and also changes at various times during the day if the signal is bouncing between the earth and the ionosphere. However, for most users in the United States, the received accuracy should be less than 10 milliseconds ( 1/100 of a second). This represents an amazingly accurate source by which to synchronize all of the clocks in the master clock system.

Various proposals for systems that synchronize clock settings are found in the art. U.S. Pat. No. 3,643,420 and U.S. Pat. No. 6,205,090 disclose master-slave clock systems that synchronize all of the clocks based on the time kept by the master clock unit. Neither of these systems, however, incorporates an external time source to set or ensure the accuracy of the master clock, and neither suggests storing local user settings from the slave clock units on the master clock units.

U.S. Pat. No. 5,689,688 and U.S. Pat. No. 5,805,530 disclose master-slave clock systems that synchronize all of the clocks based on the time kept by the master clock unit. The master clock units are capable of being set or adjusted by accurate external sources, and the master clock units are capable of using broadcast medium to communicate to the slave clock units. Neither of these proposals, however, suggests storing local user settings from the slave clock units on the master clock units.

U.S. Pat. No. 4,490,050, U.S. Pat. No. 5,334,975, and U.S. Pat. No. 6,577,231 propose clock synchronization systems that alter the electrical supplies to the slave clock devices to achieve synchronization. None of these proposals suggest storing local user settings from the slave clock units on the master clock units.

U.S. Pat. No. 6,215,862 and U.S. Pat. No. 6,324,270 propose clock synchronization systems that use telephones and data transmitted over telephone lines to synchronize clocks. Once again, neither proposal suggests storing local user settings from the slave clock units on the master clock units.

All of the above proposals only deal with the problem of synchronizing clocks and restoring time settings after power outages. None of the above proposals completely address the other main hassle associated with electronic devices and power outages—the loss of user settings. Furthermore, none of the above proposals even acknowledge this shortcoming. Saving all user settings to a master clock unit is advantageous in that a single battery backup module can preserve all of the local settings of a plurality of slave clock units.

Therefore, it is desirable to have a system for synchronizing clock settings that synchronizes clock settings, restores the correct time to slave clocks after power outages, saves setting information for customized user electronics settings, incorporates an external time source to set or ensure the accuracy of the master clock, and eliminates the need for multiple systems to have battery backup.

### SUMMARY OF THE INVENTION

A system for synchronizing clock settings according to the present invention includes a master clock unit and at least one slave clock unit. The master clock unit includes a master CPU connected to a receiver, a master transceiver, a master memory module, a display, status LEDs, and a backup battery. The receiver is permanently tuned to the radio signal from the National Institute of Standards and Technology (NIST) to receive updated times. Slave clock units each include a slave CPU attached to a slave transceiver, a slave memory module, a display, and status LEDs. The master and slave transceivers are used to enable two-way communication between the master clock unit and the slave clock units. The slave memory modules store local clock settings of the respective slave clock units. This may include such local clock settings as alarm times and tones, radio or television settings, VCR or DVD settings, volume levels, surround-sound configurations, answering machine settings, and advanced temperature control settings, for example. The backup battery ensures that the master clock unit maintains the memory for the entire system, so individual backup batteries on all of the slave clock units are not necessary. The displays show the time synchronized with the NIST, and the LEDs display the current state of the master clock unit and the slave clock units, respectively.

In use, the master clock unit's receiver receives a radio signal having atomic clock time data indicative of a relative time, and the master transceiver transmits the time data to the slave transceivers. The master CPU uses the time data to update the master clock time, and the master CPU updates the status as indicated by the status LEDs if necessary. After the slave transceivers receive the time data from the master transceiver, the slave CPUs use the time data to update the slave clock time. The slave CPUs then update the status as indicated by the status LEDs if necessary. At the same time the master transceiver transmits the time data to the slave transceivers (or shortly thereafter,) the slave transceivers transmit local clock settings of the respective slave clock units to the master transceiver. The master memory module stores the respective local clock settings of the respective slave clock units by ID number and model number in case of power outage. By storing a model number, an association can be made between similar types of devices. When either the master clock unit or a slave clock unit loses AC power, the system performs somewhat differently to restore time settings and local clock settings.

Therefore, a general object of this invention is to provide a system for synchronizing clock settings that synchronizes clock settings.

Another object of this invention is to provide a system for synchronizing clock settings, as aforesaid, that restores the correct time to slave clocks after power outages.

Still another object of this invention is to provide a system for synchronizing clock settings, as aforesaid, that saves setting information for customized user electronics settings.

Yet another object of this invention is to provide a system for synchronizing clock settings, as aforesaid, that incorporates an external time source to set or ensure the accuracy of the master clock.

A further object of this invention is to provide a system for synchronizing clock settings, as aforesaid, that eliminates the need for multiple systems to have battery backup.

Other objects and advantages of this invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view of a slave clock unit of a system for synchronizing clock settings of multiple appliances having clock units according to the present invention;

FIG. 1b is a perspective view of another slave clock unit of a system for synchronizing clock settings of multiple appliances having clock units according to the present invention;

FIG. 2a is a block diagram showing the components of a master clock unit according to the present invention;

FIG. 2b is a block diagram showing the components of the slave clock unit as in FIG. 1a;

FIG. 3a is a flowchart of the logic performed by the master clock unit as in FIG. 2a at startup; and

FIG. 3b is a flowchart of the logic performed by the slave clock unit as in FIG. 2b at startup.

### DESCRIPTION OF THE PREFERRED EMBODIMENTS

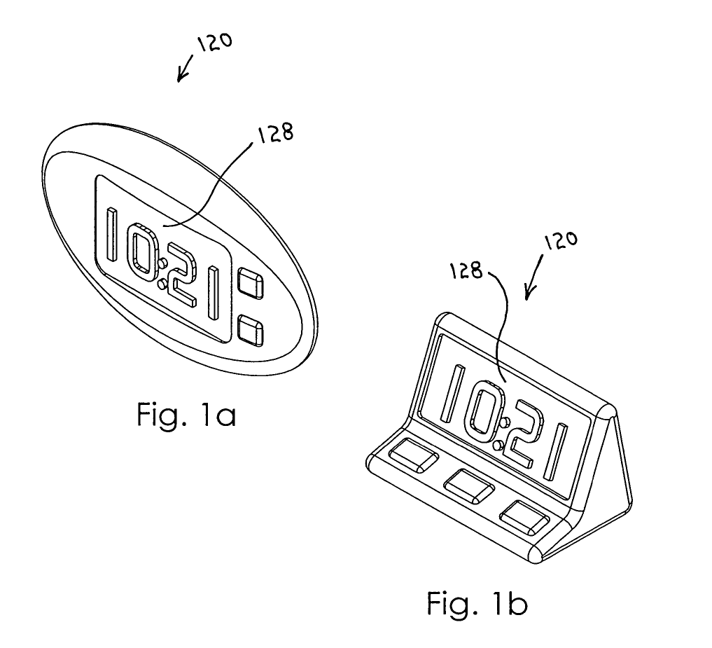

A system for synchronizing clock settings of multiple appliances having clock units according to the present invention will now be described in detail with reference to FIGS. 1a through 3b of the accompanying drawings. More particularly, a system for synchronizing clock settings includes a master clock unit 110 and at least one slave clock unit 120.

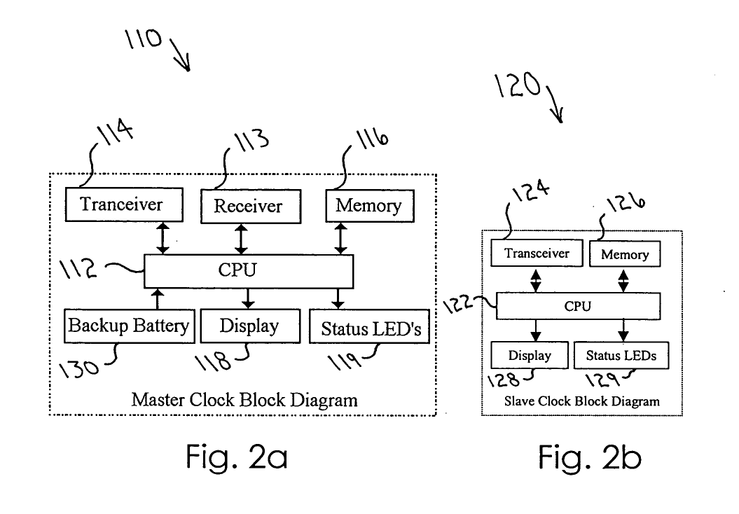

The master clock unit 110 includes a master CPU 112 connected to a receiver 113, a master transceiver 114, a master memory module 116, a display 118, status LEDs 119, and a backup battery 130 (FIG. 2a). The receiver 113 is permanently tuned to the radio signal from the National Institute of Standards and Technology (NIST) to receive updated times. Slave clock units 120 each include a slave CPU 122 connected to a slave transceiver 124, a slave memory module 126, a display 128, and status LEDs 129 (FIG. 2b).

The master transceiver 114 and the slave transceivers 124 are used to enable two-way communication between the master clock unit 110 and the slave clock units 120. While the master and slave transceivers 114, 124 may of course use a wide range of technologies, transceivers that send and receive infrared signals are currently preferred.

The slave memory modules 126 store local clock settings of the respective slave clock units 120. This may include such local clock settings as alarm times and tones, radio or television settings, VCR or DVD settings, volume levels, surround-sound configurations, answering machine settings, and advanced temperature control settings, to only name a few. The master memory module 116 stores the local clock settings from the various slave clock units 120, and thus must have a significant amount of memory. On the contrary, the slave memory modules 126 only have to be large enough to store the local clock settings of the respective slave clock unit 120.

The master memory module 116 stores a data record of the local clock settings from the various slave clock units 120 by ID number for each individual slave clock unit 120 and by model number for similar slave clock units 120. By storing a model number, an association can be made between similar types of devices. If a slave clock device 120 is one of many school clocks, for example, the local clock settings could be saved by model number and the same initial settings could be used for each school clock. The ID number is a unique identifier. The backup battery 130 ensures that the master clock unit 110 maintains the memory for the entire system, so individual backup batteries on all of the slave clock units 120 are not necessary.

It should be appreciated that only the master clock unit 110 includes a backup battery 130. Accordingly, the local settings from every slave clock unit 120 are maintained in the master clock unit memory 116 during a power outage. These settings may then be rebroadcast to the slave clock units 120 according to associated ID and model data when power is restored, as will be describe in more detail below.

The displays 118, 128 show the time synchronized with the NIST signal on the master clock unit 110 and the slave clock units 120, respectively, and the LEDs 119, 129 display the current state of the master clock unit 110 and the slave clock units 120, respectively.

When there has not been a power outage to either the master clock unit 110 or the slave clock units 120, the system performs in the following manner. At predetermined time increments, the receiver 113 of the master clock unit 110 receives a radio signal having atomic clock time data indicative of a relative time, and the master transceiver 114 transmits the time data to the slave transceivers 124. The master CPU 112 uses the time data to update the master clock time as shown on the display 118, and the master CPU 112 updates the status as indicated by the status LEDs 119 if necessary. After the slave transceivers 124 receive the time data from the master transceiver 114, the slave CPUs 122 use the time data to update the slave clock time as shown on the displays 128. The slave CPUs 122 then update the status as indicated by the status LEDs 129 if necessary. At the same time the master transceiver 114 transmits the time data to the slave transceivers 124 (or shortly thereafter,) the slave transceivers 124 transmit local clock settings of the respective slave clock units 120 to the master transceiver 114. The master memory module 116 stores the respective local clock settings of the respective slave clock units 120 by ID number and model number in case of power outage.

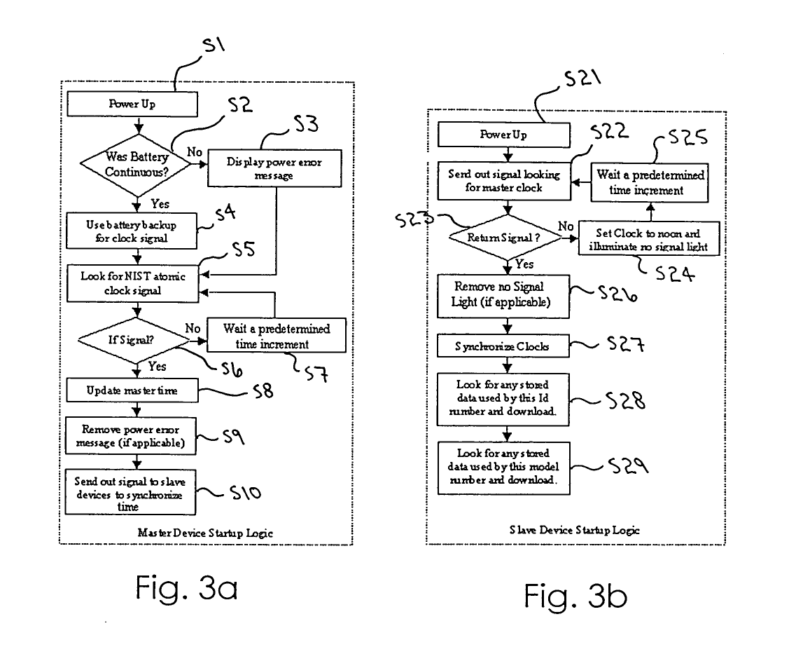

When either the master clock unit 110 or a slave clock unit 120 loses AC power, the system performs somewhat differently. The processing steps of the logic performed by the master CPU 112 at startup are shown in the flowchart of FIG. 3a. The beginning of the process (powering up) is shown as step S1, and occurs when the master clock unit 110 regains AC power. The process determines in step S2 whether the battery performed continuously while the master clock unit 110 was without AC power. If so, the process proceeds to step S4. If not, the process is directed to step S3.

In process step S3, the master clock unit 110 displays a power error message through the status LEDs 119. The process then proceeds to step S5.

In process step S4, the time kept by the battery is shown on the display 118 since the time should be relatively accurate. The process is then directed to step S5.

In process step S5, the receiver 113 looks for the NIST atomic clock radio signal. The process then proceeds to step S6.

The process determines in step S6 whether the receiver 113 received the NIST atomic clock radio signal. If so, the process is directed to step S8. If not, the process is directed to step S7.

In process step S7, the master CPU 112 waits a predetermined time increment and then returns to step S5, where the receiver 113 looks for the NIST atomic clock radio signal. The master CPU 112 waits this predetermined time increment because while the NIST signal is able to cover most of North America and South America with a single radio antenna, it is possible to only receive the signal at night in some places due to atmospheric affects on the transmission distance. The predetermined time increment is preferably one to two hours, though other time increments will of course suffice.

In process step S8, the time kept by the master CPU 112 and shown by the display 118 is updated using the NIST time data, and the process proceeds to step S9.

In process step S9, the master CPU 112 removes any existing power error message displayed by the status LEDs 119, and the process proceeds to step S10.

In process step S10, the master transceiver 114 sends out signals to the slave clock units 120 to synchronize the time kept by the slave clock units 120 with the master clock unit 110. The system then performs as described above, as if there has not been a power outage to either the master clock unit 110 or the slave clock units 120, unless there was also an AC power failure to a slave clock unit 120. If there was an AC power failure to a slave clock units 120, the system performs as described below.

The processing steps of the logic performed by a slave CPU 122 at startup are shown in the flowchart of FIG. 3b. This process will be used individually by all of the slave clock units 120 the first time they are plugged in to a power outlet, if they are unplugged and then plugged back into a power outlet, and if they have otherwise lost and regained power. The beginning of the process (powering up) is shown as step S21, and occurs when the slave clock unit 120 regains AC power. The process proceeds to step S22.

In process step S22, the slave transceiver 124 sends out a request signal looking for the master clock unit 110. This signal contains the ID number and the model number of the slave clock device 120. If the master transceiver 114 receives this signal from the slave transceiver 124, the master transceiver 114 will send a return signal with time data followed by signals with local clock settings data to the slave transceiver 124.

The process determines in step S23 whether the slave transceiver 124 received a return signal from the master transceiver 114. If the slave transceiver 124 receives a return signal, the process proceeds to step S26. If not, the process is directed to step S24.

In process step S24, the time kept by the slave CPU 122 is set to noon, and the status LEDs 129 indicate that no signal was obtained from the master clock unit 110. The process proceeds to step S25.

In process step S25, the slave CPU waits a predetermined time increment and then returns to step S22 where another attempt to communicate with the master clock unit 110 is made.

In process step S26, the slave CPU 122 removes any existing no signal light displayed by the status LEDs 129, and the process then proceeds to step S27.

In process step S27, the slave CPU 122 uses the time data in the return signal to set the slave clock time as kept by the slave CPU 122 and shown on the display 128. The process then proceeds to step S28.

In process step S28, the slave transceiver 124 receives any local clock settings stored by the master clock unit 110 for the ID number of the slave clock unit 120. These local clock settings are then stored in the slave memory module 126. The master transceiver 114 sends out this information after sending the signal containing time data, which was received by the slave transceiver 124 in process step S23.

In process step S29, the slave transceiver 124 receives any local clock settings stored by the master clock unit 110 for the model number of the slave clock unit 120. These local clock settings are then stored in the slave memory module 126. The master transceiver 114 sends out this information after sending the signal containing local clock settings by ID number, which was received by the slave transceiver 124 in process step S28. When the process finishes step S29, all applicable local clock settings have been restored to the slave clock unit 120, and the slave clock unit 120 is synchronized with the master clock unit 110 and the NIST atomic clock signal. The system then performs as first described above, as if there has not been a power outage to either the master clock unit 110 or the slave clock units 120.

It is understood that while certain forms of this invention have been illustrated and described, it is not limited thereto except insofar as such limitations are included in the following claims and allowable functional equivalents thereof.

1. A system for synchronizing clock settings of multiple appliances having clock units, comprising:
a master clock unit having a master CPU, a receiver connected to said master CPU, and a master transceiver connected to said master CPU, said receiver providing means for receiving a radio signal having atomic clock time data indicative of a relative time, said master transceiver providing means for transmitting said time data;
a slave clock unit having a slave CPU and a slave transceiver connected to said slave CPU for receiving said time data transmitted by said master transceiver; and
display means connected to said slave CPU for displaying said time data.

2. The system as in claim 1 wherein said slave transceiver provides means for transmitting local clock settings associated with said slave clock unit to said master clock unit.

3. The system as in claim 2 further comprising a master memory module electrically connected to said master CPU for storing said local clock settings received from said slave clock unit.

4. The system as in claim 3 wherein said master memory module has a capacity to store local settings from a plurality of slave clock units.

5. The system as in claim 3 wherein said master CPU includes means for causing said master transceiver to transmit said local clock settings stored in said master memory module back to said slave clock unit after a power outage.

6. The system as in claim 5 wherein:
said master transceiver transmits said time data and said local clock settings through infrared signals; and
said slave transceiver transmits said local clock settings through infrared signals.

7. The system as in claim 3 wherein said master clock unit includes a battery backup unit electrically connected to said master CPU and said master memory module for electrically maintaining said local clock settings in case of a power outage.

8. The system as in claim 7 wherein said master CPU includes:
means for determining if said battery backup unit performed continuously during a power outage; and
means for displaying a power error message if said battery backup unit is determined not to have performed continuously.

9. The system as in claim 1 wherein said slave clock unit includes a plurality of separate slave clock units.

10. The system as in claim 1 wherein said master CPU includes means for receiving said radio signal at predetermined time increments.

11. The system as in claim 10 wherein said time data is transmitted by said master transceiver at each predetermined time increment.

12. The system as in claim 1 wherein said slave CPU includes means for causing said slave transceiver to transmit a request signal requesting; said master clock unit to transmit local clock settings associated with said slave clock unit, said request signal including a unique identifier associated with said slave clock unit and with a corresponding data record stored in said master memory module.

13. A system for synchronizing clock settings of multiple appliances having clock units, comprising:
a master clock unit having a master CPU, a receiver connected to said master CPU, and a master transceiver connected to said master CPU, said receiver providing means for receiving a radio signal having atomic clock time data indicative of a relative time, said master transceiver providing means for transmitting said time data;
a plurality of slave clock units remote from said master clock unit, each slave clock unit having a slave CPU and a slave transceiver connected to said slave CPU for receiving said time data transmitted by said master transceiver;
display means connected to said slave CPU for displaying said time data;
wherein each slave transceiver provides means for transmitting local clock settings associated with a respective slave clock unit to said master clock unit;
a master memory module electrically connected to said master CPU for storing said local clock settings received from said respective slave clock units; and
a battery backup unit electrically connected to said master CPU and said master memory module for maintaining said local clock settings in case of a power outage.

14. The system as in claim 13 wherein said master CPU includes means for causing said master transceiver to transmit said local clock settings stored in said master memory module back to said respective slave clock units after a power outage.

15. The system as in claim 13 wherein each said slave CPU includes means for causing a respective slave transceiver to transmit a request signal requesting said master clock unit to transmit local clock settings associated with said respective slave clock unit, said request signal having a unique identifier associated with said respective slave clock unit and with a corresponding data record stored in said master memory module.

16. The system as in claim 13 wherein said master CPU includes:
means for determining if said battery backup unit performed continuously during a power outage; and
means for displaying a power error message if said battery backup unit is determined not to have performed continuously.

17. The system as in claim 13 wherein said master CPU includes means for receiving said radio signal at predetermined time increments.

18. The system as in claim 17 wherein said time data is transmitted by said master transceiver at each predetermined time increment.

19. The system as in claim 14 wherein said master CPU includes:
means for determining if said battery backup unit performed continuously during a power outage; and
means for displaying a power error message if said battery backup unit is determined not to have performed continuously.

20. The system as in claim 19 wherein:
said master CPU includes means for receiving said radio signal at predetermined time increments; and
said time data is transmitted by said master transceiver at each said predetermined time increment.
